(19) United States
(12) Patent Application Publication
(10) Pub. No.: US 2014/0136440 A1
(43) Pub. Date: May 15, 2014

(54) SYSTEM AND PROCESS OF ASSOCIATING IMPORT AND/OR EXPORT DATA WITH A CORPORATE IDENTIFIER RELATING TO BUYING AND SUPPLYING GOODS

(71) Applicant: THE DUN & BRADSTREET CORPORATION, Short Hills, NJ (US)

(72) Inventors: Adnan AHMED, Watchung, NJ (US); Yan DUAN, Jersey City, NJ (US); Jerry RONAGHAN, Ridgewood, NJ (US); Andres BENVENUTO, Morristown, NJ (US); Anthony J. SCRIFFIGNANO, West Caldwell, NJ (US); Michael KLEIN, Chatham, NJ (US)

(73) Assignee: THE DUN & BRADSTREET CORPORATION, Short Hills, NJ (US)

(21) Appl. No.: 14/013,869

(22) Filed: Aug. 29, 2013

Related U.S. Application Data
(60) Provisional application No. 61/695,843, filed on Aug. 31, 2012.

(51) Int. Cl. G06Q 50/28; G06Q 10/10

(52) U.S. Cl. CPC G06Q 50/28; G06Q 10/10
USPC 705/342

(57) ABSTRACT

There is provided a method that includes matching records from a plurality of international import/export databases, to unique corporate identifiers, and merging data from the records into a global database. There is also provided a system that employs the method, and a storage device that contains instructions that cause a processor to execute the method.

### BACKGROUND OF THE DISCLOSURE

1. Field of the Disclosure

The present disclosure relates generally to gathering import and/or export data in order to leverage shipping documents and customs forms from various countries to develop business information, such as business identity, relationships between businesses, goods shipped, departure and arrival ports, business locations, contact information (telephone numbers, facsimile numbers, emails, etc.) and other transaction details. In particular, the present disclosure includes a series of systems and processes that employ integrated data processing techniques to cleanse and normalize a bill of lading database by (1) appending a corporate identifier, e.g., a Data Universal Numbering System (DUNS) Number, to a business entity appearing in the database, including consignee, shipper and notify party, and (2) classifying a cargo description with a Harmonized Commodity Description and Coding System (HS) number.

DUNS is a system developed and regulated by Dun & Bradstreet Corp. (D&B) that assigns a unique numeric identifier, referred to as a DUNS number, to a single business entity. It is a common standard worldwide. DUNS users include the European Commission, the United Nations and the United States government.

The HS system is an internationally standardized system of names and numbers for classifying traded products, developed and maintained by the World Customs Organization.

2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

Import and export data is currently available from a handful of providers, where the data is either integrated into a product solution or sold as an individual data packet. Data sources for the solutions are usually the same for each of the providers, i.e., bill of lading information from a government organization, for example, Customs and Border Protection (CBP) in the United States. Depending on specific regulations in different countries, the availability and level of details for bill of lading information may vary. Moreover, because of differences in data structures and lack of standard goods classification for the data provided by individual countries, unprocessed bill of lading information may not be very useful, other than as statistical or raw data.

### SUMMARY OF THE DISCLOSURE

The present inventors have discovered a unique way of converting otherwise raw data into commercially useful data to allow for buyers and sellers of products to locate one another globally, as well as for one party to determine whether or not the other party is of sufficient credit worthiness and/or relevant, based on criteria, such as, types of products imported/exported, shipment volume, geographical location, etc., to conduct business. The system described herein combines import/export data with corporate identification data to achieve the following: (1) enable global buyers to find global suppliers based on the suppliers' export activities; (2) enable global suppliers to find global buyers based on the buyers' import activities; (3) provide “look alike” target of global buyers; (4) enrich the business profile for global suppliers; (5) enrich credit profile for global buyers; (6) map global commodity trade trend, for example, by way of a heat map; (7) international compliance and crime detection; (8) enhance credit reports and scores by considering international business activities; (9) enhance supplier identification by adding a product level search feature; 10) enhance supplier risk management by providing a capability of viewing a company's import activities and a supplier's export activities to other countries; and (11) build a global file repository of such import/export data appended with corporate identifier and associate corporate information.

Accordingly, there is provided a method that includes matching records from a plurality of international import/export databases, to unique corporate identifiers, and merging data from the records into a global database. There is also provided a system that employs the method, and a storage device that contains instructions that cause a processor to execute the method.

### BRIEF DESCRIPTION OF THE DRAWINGS

FIG. 1 is a block diagram of a system for associating import and export data with a corporate identifier.

FIG. 2 is a flowchart of a method for associating import and export data with a corporate identifier.

FIG. 3 illustrates an example of the method of FIG. 2 being executed for a case where a first data source is China customs export data, and a second data source is U.S. customs imports data.

FIG. 4 is an example of processing performed by the method of FIG. 2, of data from a data source that contains either export or import data.

FIG. 5 is an example of processing performed by the method of FIG. 2, of data from a data source that contains U.S. Customs & Border Protection import data.

FIG. 6 is an example of a data format of “Optimizer Standard Input Layout with PO Box”-Company Data.

FIG. 7 is an example of a data format of commodity/cargo data.

A component or a feature that is common to more than one drawing is indicated with the same reference number in each of the drawings.

### DESCRIPTION OF THE DISCLOSURE

The present disclosure provides a unique workflow that standardizes, normalizes, and matches commodity import/export data with HS codes, matches bill of lading information with corporate identifier information, and appends a corporate identification designation (e.g., DUNS Number) to each company involved in a transaction, including a shipper, a consignee and other businesses, such as banks, logistic companies, etc., and merges the HS classified goods data with the corporate identification information into a global database. Matching, as used herein, means searching a data storage device for data, e.g., searching a database for a record, that best matches a given inquiry.

The following steps are utilized to produce the unique merged HS classified goods data and corporate identification information data into the global database, which provides for a unique technical effect and benefits of such combined data as discussed below.

First, standardization or reformatting of the original bill of lading information by cleansing the names and addresses of the consignee and shipper that appear on the bill of lading. Standardization and cleansing are processes that parse unstructured data or information into correct fields, such as, company name, address and city to enable more accurate matching and data processing.

Second, normalize the content of commodity, e.g., product, data listed on the bill of lading.

Third, match the commodity data with a classification in the HS Code system.

Fourth, match corporate identify information (i.e., name, address, telephone number, etc.) from bill of lading information, and append or generate a unique corporate identifier (e.g., DUNS Number) for each company associated with the bill of lading (e.g., an exporter, an importer, a shipper, a consignee or other business associated with the transaction, such as a bank, a logistics company, etc.). Using a corporate identifier ensures that a company is what it says it is, which provides a counter-party with more confidence when doing business with the company. Also, by appending the corporate identifier for a company from the bills of lading information, previously unassociated company information can be associated with an import and/or export transaction.

Fifth, merge the files created in steps 1-4 above into a unique and previously unavailable database of HS code and DUNS Numbers import/export data.

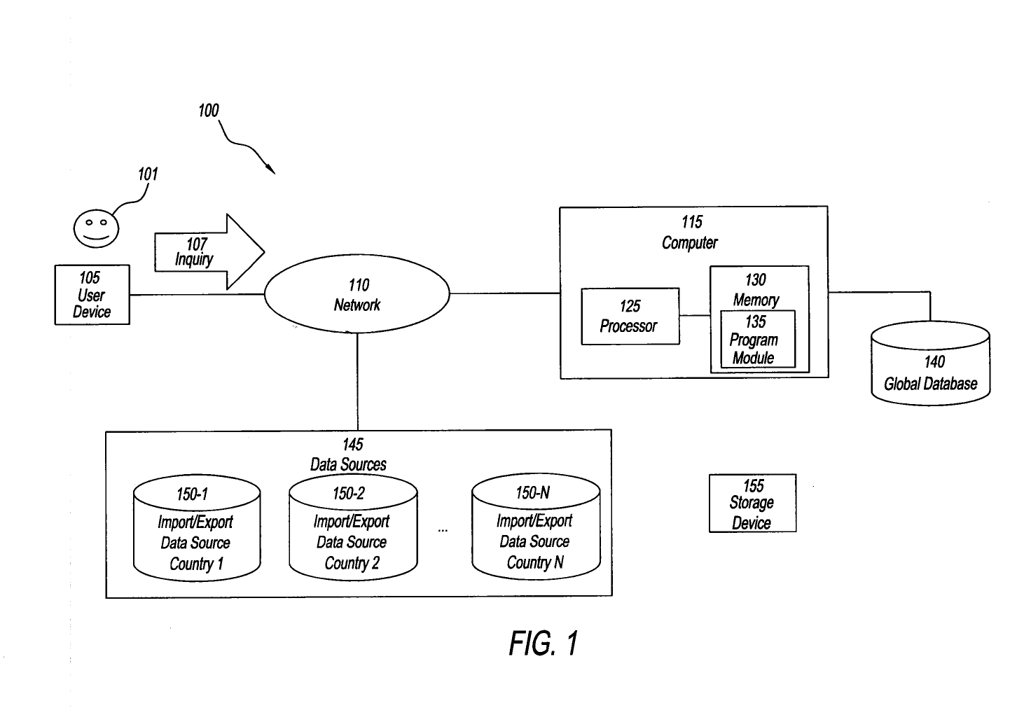

FIG. 1 is a block diagram of a system 100 for associating import and export data with a corporate identifier. System 100 includes a user device 105, data sources 145, and a computer 115, each of which is communicatively coupled to a network 110, e.g., the Internet.

User device 105 includes an input device, such as a keyboard or speech recognition subsystem, for enabling a user 101 to communicate information and command selections to, and receive communications and processing results from, computer 115 via network 110. For example, user 101 can send an inquiry 107 to computer 115. User device 105 also includes an output device such as a display or a printer, or a speech synthesizer. A cursor control such as a mouse, track-ball, or touch-sensitive screen, allows user 101 to manipulate a cursor on the display for communicating additional information and command selections to computer 115.

Computer 115 includes a processor 125, and a memory 130 coupled to processor 125. Although computer 115 is represented herein as a standalone device, it is not limited to such, but instead can be coupled to other computers (not shown) in a distributed processing system.

Processor 125 is an electronic device configured of logic circuitry that responds to and executes instructions.

Memory 130 is a tangible computer-readable storage device encoded with a computer program. In this regard, memory 130 stores data and instructions, i.e., program code, that are readable and executable by processor 125 for controlling the operation of processor 125. Memory 130 may be implemented in a random access memory (RAM), a hard drive, a read only memory (ROM), or a combination thereof. One of the components of memory 130 is a program module 135.

Program module 135 contains instructions for controlling processor 125 to execute methods described herein.

The term “module” is used herein to denote a functional operation that may be embodied either as a stand-alone component or as an integrated configuration of a plurality of subordinate components. Thus, program module 135 may be implemented as a single module or as a plurality of modules that operate in cooperation with one another. Moreover, although program module 135 is described herein as being installed in memory 130, and therefore being implemented in software, it could be implemented in any of hardware (e.g., electronic circuitry), firmware, software, or a combination thereof.

While program module 135 is indicated as being already loaded into memory 130, it may be configured on a storage device 155 for subsequent loading into memory 130. Storage device 155 is a tangible computer-readable storage device that stores program module 135 thereon. Examples of storage device 155 include a compact disk, a magnetic tape, a read only memory, an optical storage media, a hard drive or a memory unit consisting of multiple parallel hard drives, and a universal serial bus (USB) flash drive. Alternatively, storage device 155 can be a random access memory, or other type of electronic storage device, located on a remote storage system and coupled to computer 115 via network 110.

Data sources 145 include a plurality of data sources 150-1, 150-2 through 150-N, each of which contains import and/or export data. Data source 150-1 contains import/export data for country 1. Data source 150-2 contains import/export data for country 2. Data source 150-N contains import/export data for country N. Examples of data sources 150-1, 150-2 through 150-N include China customs data, U.S. customs data or other bills of lading sources. Data sources 150-1, 150-2 through 150-N may be configured as a plurality of individual storage devices that are physically remote from one another, or configured in a single storage device. The physical arrangement and location of data sources 150-1, 150-2 through 150-N is not of particular importance.

A global database 140 is communicatively coupled to computer 115. Global database 140 contains records that describe various aspects of commercial businesses, globally, for example, information such as, identity data, filmagraphics, history and operations, public filings, corporate linkage, e.g., corporate family trees, risk scores, etc. In practice, global database 140 will likely contain millions of records.

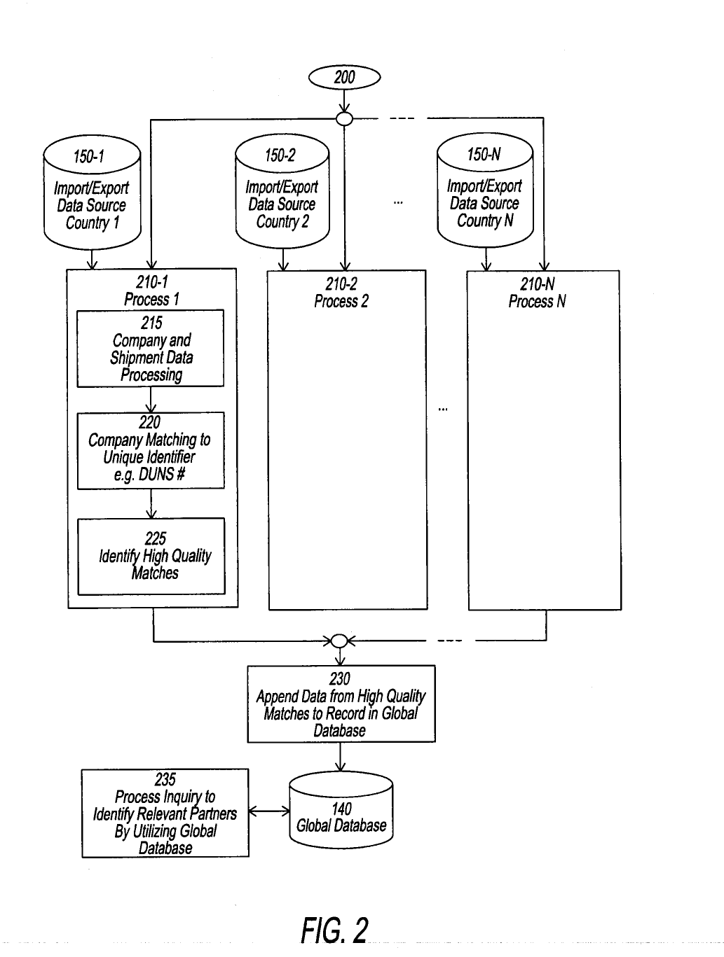

FIG. 2 is a flowchart of a method 200 for associating import and export data with a corporate identifier. In the present document, although we describe operations as being performed by method 200 or its subordinate processes, the operations are actually being performed by computer 115, and more particularly processor 125.

Method 200 includes a plurality of parallel processing paths, which it enters via steps 210-1, 210-2 through 210-N, where each path is for processing data from data source 150-1, 150-2 through 150-N, respectively. For sake of example, we will discuss processing via step 210-1.

In step 210-1, processor 125 receives data from data source 150-1, and processes the data by executing several sub-processes designated as steps 215, 220 and 225. Processing is performed for each record in data source 150-1, where a given record describes an import transaction and/or an export transaction, and includes information such as the name and address of an entity that is involved in the transaction, and other particulars concerning the transaction, such as that provided by a bill of lading.

In step 215, processor 125 parses, standardizes and reformats data from a record from data source 150-1, by cleansing names and addresses of business entities that appear in the record. Processor 125 also standardizes and normalizes shipment import/export data, and matches the shipment import/export data with one or more HS codes. From step 215, method 100 progresses to step 220.

In step 220, processor 125 matches data from the record to corporate identifier information (e.g., a DUNS Number) that exists in global database 140, for each business entity involved in the transaction. From step 220, method 200 progresses to step 225.

In step 225, processor 125 identifies company matches, from step 220, that are regarded as high quality matches, i.e., characterized with a high level of confidence that the matches are correct. As mentioned above, matching means searching for a best match for a given inquiry. Consequently, the result of the matching operation in step 220 might be an exact match or an inexact match. If it is an inexact match, it might be a correct match, or it might be an incorrect match. Accordingly, the match result from step 220 is accompanied by a confidence code that indicates a level of confidence that the result is correct. At the very least, the confidence code will include two values, one value that indicates a high level of confidence, and one value that indicates other than a high level of confidence. However, the confidence code could span a range of values, e.g., 1-10, and indicate a more refined degree of confidence. Some parameters that may influence the level of confidence include company name, address, city, state, province, country, telephone number, etc. Records that are not of an acceptable level of quality may be discarded or reviewed at a later date. Records that are regarded as being high quality matches are retained for further processing.

Upon completion of sub-steps 215, 220 and 225, and thus completion of step 210-1, processor 125 has obtained, for a record from data source 150-1, data relating to a particular transaction, and a DUNS Number for each business entity that is involved in the transaction. From step 210-1, method 200 progresses to step 230.

In step 230, for each high quality match in step 210-1, processor 125 receives the high quality match, and based on the DUNS number, appends the data from step 210-1, i.e., the data relating to a particular transaction, to a matching record in a global database 140. The appending may be either of (a) an actual adding of the data to a record in global database 140, or (b) a logical addition of the data by providing a pointer or other reference that global database 140 can utilize to locate a corresponding record in data source 150-1. Thus, the appending of data to a record in global database 140, as used herein, means to update the record in global database 140 by either of addition of data, or addition of a pointer or other reference. The physical arrangement of the record in global database 140 is not of particular importance.

Each of steps 210-2 through 210-N is similar to step 210-1, in that it processes data from its respective data source 150-2 through 150-N and obtains data relating to a particular transaction, and a DUNS Number for each business entity that is involved in the transaction, and thereafter, progresses to step 230. However, steps 210-1, 210-2 through 210-N need not be identical to one another, but instead, may be uniquely configured to accommodate the particular data from their respective data sources 150-1, 150-2 through 150-N. In practice, each of steps 210-1, 210-2 through 210-N will run in a loop in order to process each of the records from data sources 150-1, 150-2 through 150-N, respectively, and pass their high quality matches to step 230.

Step 230, over time, merges the data from steps 210-1, 210-2 through 210-N into global database 140. As such, if a particular company is involved in a first transaction that is represented in data source 150-1, and a second transaction that is represented in data source 150-2, global database 140 will contain a record for the company, and the record will include particulars about each of the first and second transactions.

Thus, in general terms, method 200 includes:
(a) performing a first process, e.g., step 210-1, that includes:
   reading, from a first data source, e.g., data source 150-1, a first record that describes a first international shipping transaction;
   parsing the first record to locate a first descriptor of an entity that is involved in the first international shipping transaction; and
   matching the first descriptor to a unique business identifier, thus yielding a first match to the unique business identifier;
(b) appending first data from the first record to a record in a database, e.g., global database 140, based on the unique business identifier:
(c) performing a second process, e.g., process 210-2, that includes:
   reading, from a second data source, a second record that describes a second international shipping transaction;
   parsing the second record to locate a second descriptor of an entity that is involved in the second international shipping transaction: and
   matching the second descriptor to the unique business identifier, thus yielding a second match to the unique business identifier: and
(d) appending second data from the second record to the record in the database, based on the unique business identifier,
   where the first data and the second data are thereafter accessible by way of the record in the database.

A record in global database 140 that is produced or updated by processor 125 in accordance with method 200 is effectively a data structure, similar to that of a virtual social network, through which transactions represented in data sources 145 are linked to one another. Given such links, processor 125 can search for relationships between the transactions, and relationships between companies that are involved in the transactions. Among the technical benefits of method 200 is that it facilitates the development of global database 140, which in turn enables the searching for relationships, and increases the speed and accuracy of such searches as compared to solutions in the prior art.

Method 200 also includes a downstream process indicated by step 235, which involves processor 125 accessing global database 140 and utilizing data that was provided by step 230.

In step 235, processor 125 receives inquiry 107 from user device 105.

In response to inquiry 107, processor 125 can:
(a) identify global suppliers of a product based on the suppliers' export activities.
(b) identify global buyers based on the buyers' import activities.
(c) identify a “look alike” target of global buyers. Identifying “look alike” targets means to identify businesses that are similar in nature by utilizing data points, such as but not limited to, industry classification, number of employees, annual sales, regional location, etc.
(d) generate or enhance business profiles for global suppliers.
(e) generate or enhance credit profiles for global buyers.
(f) map a global commodity trade trend, for example, by way of a heat map.

Commodity trends are identified by observing one or more specific time series to show potential increases or decreases in supply/demand economics. A heat map is a graphical representation that presents, for example, a display of countries or regions that are impacted by a changing trend.
(g) detect whether a business entity is in international compliance with a law or regulation;
(h) detect whether a business entity is involved in criminal activity. By leveraging other data sources, such as, Office of Foreign Assets Control (OFAC) of the US Department of the Treasury, which administers and enforces economic and trade sanctions based on US foreign policy and national security goals against targeted foreign countries and regimes, terrorists, international narcotics traffickers, those engaged in activities related to the proliferation of weapons of mass destruction, and other threats to the national security, foreign policy or economy of the United States, businesses may be flagged as being involved in criminal or terror activities.
(i) generate or enhance credit and/or management reports and scores by considering international business activities of business entities. By identifying international import and/or export activities of a business as an example, data describing such activities may be used to make credit decisions and/or use the insight to develop or enhance credit scores or models.

Thus, system 100 allows various global businesses and government agencies to (1) verify the existence and legitimacy of foreign suppliers, (2) track the identity of a supplier over time, and (3) assess risk of international crime and compliance violation. This also allows global buyers to: (1) find suppliers that meet their needs, and (2) determine if a supplier is suspected of fraud or corrupt business practices.

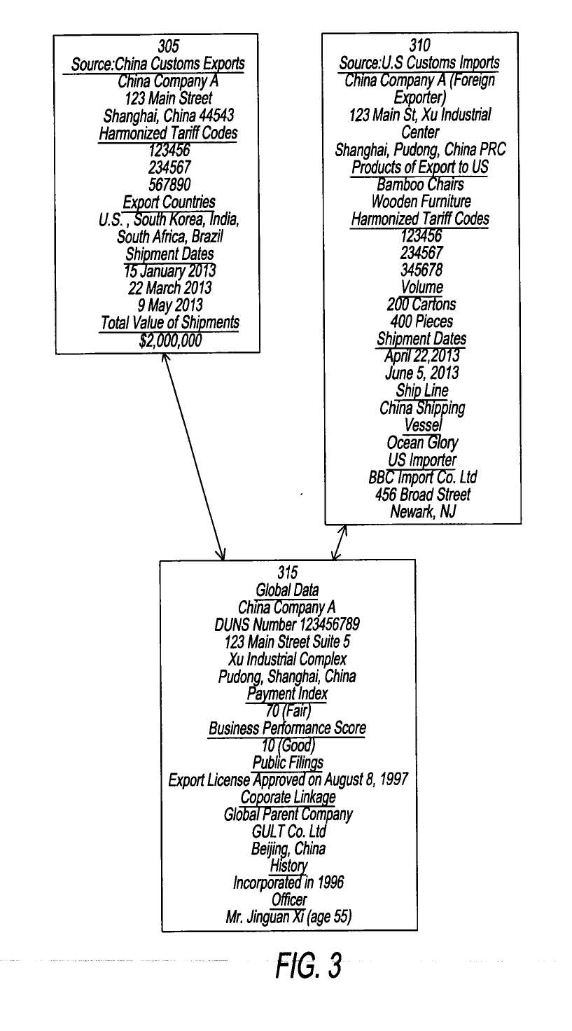

FIG. 3 illustrates an example of method 200 being executed through step 230, for a case where data source 150-1 is China customs export data, and data source 150-2 is U.S. customs imports data, and each of data source 150-1 and data source 150-2 includes a record that pertains to a transaction that involves China Company A. As a result of executing step 210-1, method 200 yields data 305, and as a result of executing step 210-2, method 200 yields data 310. Thereafter, in step 230, processor 125 updates a record 315 in global database 140, by appending data 305 and data 310. Subsequently, when processor 325 accesses record 325, processor 125 will also have access to data 305 and data 310.

Thus, Chinese Custom's data is combined with US custom's data and both data are combined with corporate identifier and corporate information. The combining of business or corporate information with multi sources of import/export data provides a holistic view and closer to 100% coverage of international trade counter-party activities in three levels: countries, companies, and products. That is, matching China export and US import counter-party activities, are linked with a corporate identifier for the purpose of generating business identity verification, business activity tracking and risk assessment. More specifically, China Company A found in both source databases (e.g., China Customs and U.S. Customs) will provide intelligence on both its export activity to the U.S. and export activity to other countries or regions of the World. The U.S. Customs data is specific to waterborne imports from the world whereas China Customs data provides export activity by all modes of transportation to worldwide destinations. The merging of the source databases provides a unique view of, in this example, China Company A's export activity not only with the Unites States but other countries. In addition to leveraging the two customs sources, additional information is procured from global database 140, which includes, but is not limited to, predictive risk scores, filmagraphic information and other data points gathered from a myriad of sources.

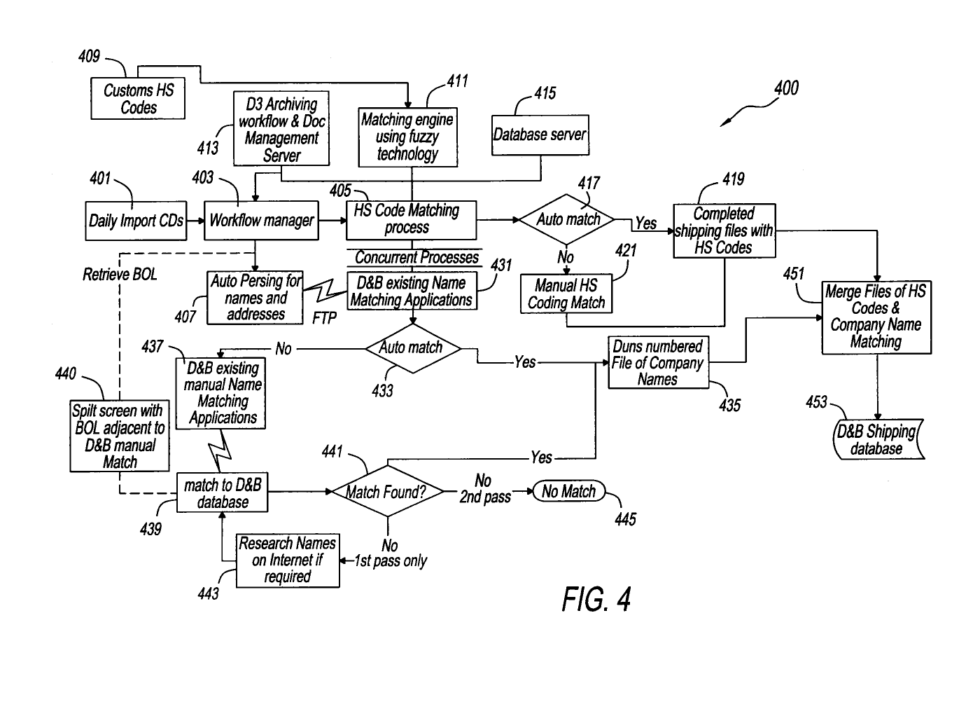

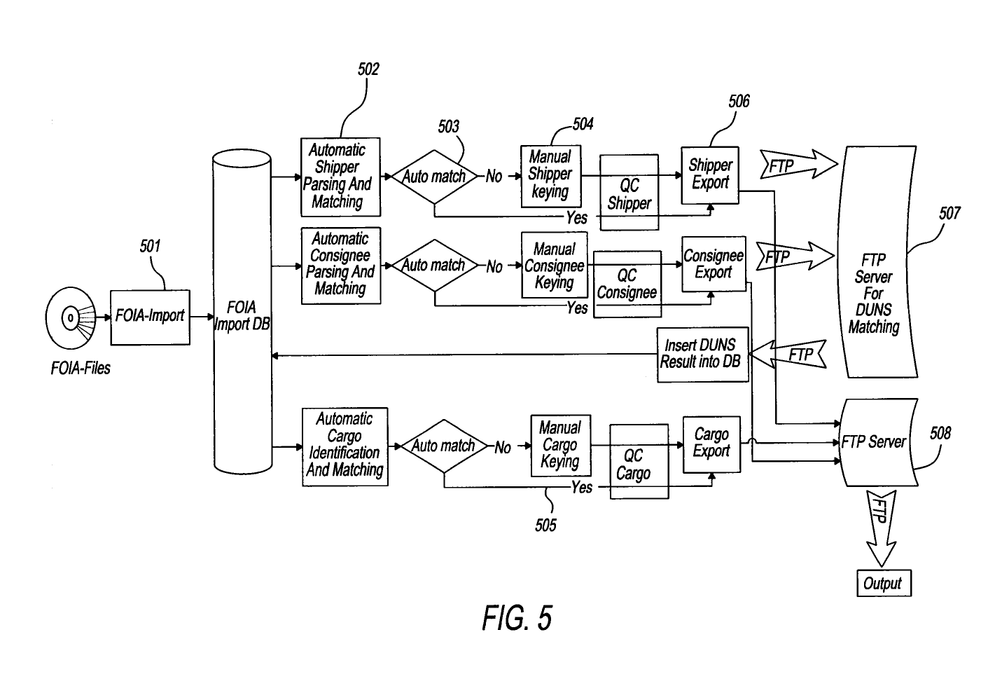

As mentioned above, each of steps 210-1, 210-2 through 210-N may be uniquely configured to accommodate the particular data from their respective data sources 150-1, 150-2 through 150-N. FIGS. 4 and 5 include two exemplary configurations.

FIG. 4 is an example of processing 400 performed by steps 210-1 and 230, of data from a data source in data sources 145 that contains either export or import data. Daily import/export data 401 is sent to a workflow manager 403 and either an HS Code matching process 405 or to auto parsing for names and addresses 407. HS Code matching process 405 also receives Customs HS Codes 409 which has been processed via matching engine using fuzzy technology 411. Matching engine 411 is in communication with D3 archiving workflow and document management server 413 and database server 415. Thereafter, the system decides on whether to auto match 417 the HS Code and daily import data. If auto match occurs, then shipping files are matched to HS codes 419. If no auto match, the manual matching occurs 421 before competing shipping files with HS Codes 419.

After auto parsing of the names and addresses 407, via file transfer protocol (FTP), the names are matched in name matching application 431. If there is an auto match 433, then a corporate identifier is automatically appended to the company name 435. If no auto match 433, then a manual match of a company name with a corporate identifier 437 and 439 is sought. If no match is found on the first pass 441, then the company name is researched on, for example, the Internet 443 and a manual match is sought 439. The manual match at 439 produces a report 440 on a split screen with bill of lading (BOL) adjacent to D&B manual match data. If no match is found on the second pass then no match is finalized 445. If a match is found 441, then the matched company name is appended with a corporate identifier 435. Thereafter, the company name with appended corporate identifier 435 is merged with the shipping files with HS Codes 451 and stored in a repository database 453.

FIG. 5 is an example of processing 500 performed by steps 210-1 and 230, of data from a data source in data sources 145 that contains U.S. Customs & Border Protection U.S. Freedom of Information Act (FOIA) import data.

At 501, the FOIA import files include a separate file for each day with an approximate size of 100 MB for each day. The file has a fixed size record format, where each record has a length of 278 characters. There are eight record types (1-7), where record type 1 is used for the Bill General Information for the first occurrence, and as Container Data in subsequent occurrences. The import of a FOIA file reads the file line by line and stores the information in a FOIA Import database, preserving the complete information and structure. This step fills the FOIA-tables in the database.

For efficient storage of the company addresses for shipper, consignee and notify party, identical entries are only stored once. Repeated identical entries thus result in only one entry in FOIA Shipper, FOIA Consignee or FOIA Notify Party tables and referenced in an appropriate mapping table.

At 502, after a successful import of a FOIA file, the automatic processing can be started. The processing of shipper and consignee records is almost identical, but the fact that consignee addresses are mainly US addresses, or CA (Canadian) or MX (Mexican) is used. The address identification and matching is a mixture of pattern matching and named-entity recognition using Fuzzy Search and entity tagging. The first step of the address matching is the country identification: Search for country name, country abbreviation or country code in the address field; Search for phone number and try to identify the country from the international country calling codes; If the country could not be identified, for consignee Canadian Zip codes are searched (@#@ @A@); If the country is still not identified, for consignee it defaults to US. Matching of US addresses is performed in the following steps: Concatenation of the address fields; Pattern matching for the combination city, state, zip, in several sequences, with several writing styles of state and zip; Matching of city, state, zip against the Fuzzy Server. If match was not valid or below a given confidence, continue with pattern matching using partial combinations with missing city, state or zip. Identification and normalization of the street; Matching with street, city, state, zip against the Fuzzy Server.

For matching of foreign addresses, there is no international database with street, city, zip, state and country readily available. For the common countries such as Mexico for consignee, and China for shipper, we are building or have built at least a city, state, zip, country database. Tag the words and phrases with the possible address tags (city, region/county, province, state, zip code, country) using fuzzy matching tables for Cities1000, Admin1, Admin2 and CountryInfo. Find the most likely match of the tags that constitute a valid address. Match against the company tables.

If name, street or P.O. Box, city, state, zip and country are filled and validated against the matching tables, the record does not require manual processing. After address identification, the address entry is matched against the company table, although this step is not really necessary, since it will be performed during the re-import of the DUNS-matched addresses.

At 503, the task of the cargo processing is to identify the cargo descriptions and classify the cargo according to the harmonized code schedule and assign the correct harmonized number.

The harmonized code schedule is a hierarchical classification scheme with 2-digit up to 8-digit codes (2-, 4-, 6- or 8-digits). In other words the most specific harmonized number has to be found for a given cargo description. The automatic process uses the cargo description and, optionally, information about the shipper, to guide the classification. The automatic process consists of five steps:
(i) Identification of the individual cargo descriptions (i.e., finding the start and end of a cargo description);
(ii) Generation of KeyCargo records;
(iii) Try to find identical KeyDescription record and map to existing identical record if possible;
(iv) Normalize key description (e.g., remove order number, etc.); and
(v) Generate new KeyDescription record if necessary.

Check whether the FOIA record for this cargo description already has a harmonized number in the intended field:
(i) Use pattern matching to find the harmonized number in the description field;
(ii) Use Natural Language Processing (NLP) and fuzzy matching to detect harmonized code;
(iii) Use a trained machine learning classifier to classify the normalized description to harmonized numbers. The classifier is set to a very low error rate resulting in a high rejection; and
(iv) Use a second trained machine learning classifier using a different approach for classification.

The machine learning classifiers are trained and tested with approximately half of the descriptions of a year that have been classified using other approaches, or were keyed up to the training. Using 10-fold cross validation, the rejection level was set to lead to a very low error rate. If the harmonized number was not detected, or if the classification confidence fell below an acceptance threshold, the harmonized number must be determined using human processing/keying with experts in the field of harmonized numbers.

At 504, even with state-of-the-art technology, computers and software are not (yet) able to automate the processing to 100% with the desired high accuracy. Reasons for that are often missing information (no country, city, zip codes), unusual writing styles and deficits of the algorithms. Whenever the algorithms fail to perform the task, it is important to detect this fact and route the task to a human expert. In case of the import processing there are three different tasks:
(i) Manual processing of consignee addresses (mostly US, mainly because of missing fields);
(ii) Manual processing of shipper addresses (foreign country addresses, that are often hard to sort out even by human experts); and
(iii) Manual processing of cargo descriptions to determine the harmonized number.

The keying clients are designed for fast data entry and kept as easy as possible, while at the same time allowing to search for information efficiently (e.g., start a search, image search, map search or translate directly from the keying client). The keying client for the keying of consignees consists of the view of the FOIA record containing the original information from the FOIA file without any attributes, and the result of the automatic process, that might already have identified the country, city, state and street, but due to the incomplete Zip-Code it was not able to process the record automatically.

At 505, the client for manual processing of cargo descriptions is slightly more complicated, since it is useful to see not only the original description from one or more FOIACargoDescription records that belong to one cargo and the preprocessed description after the automatic process and enter the correct harmonized number for that description. It also allows getting the shipper and consignee information and the complete bill general information. In addition to the searching capabilities “Search”, “Lucky Search”, “Image Search” and “Translate”, that are integrated in the client, it also allows to do a fuzzy search for harmonized code using words and phrases from the description.

The export is split into three separate files that use the unique identifiers from our database tables to preserve the relations. There are separate export scripts for each record type. When the export is started for consignee, shipper or cargo, it exports all records of that type to a comma separated variable (CSV) file. Usually the export is started after the automatic processing of a complete month is finished, resulting in a weekly export of all three types.

At 506, the exported company files for shipper and consignee are sent to D&B's DUNS FTP server (not shown) to perform the DUNS matching. D&B's DUNS FTP server is a landing area where information is stored before matching processes are executed. After the DUNS matching, the result files are downloaded from D&B's DUNS FTP server and the records in global database 140 are enriched with the information from the DUNS matching.

At 507, the consignee and shipper data are transferred to the D&B DUNS FTP server and the results are received from a directory on the same server. The resulting file contains not only the original record and the DUNS number, but also some information about the matching process (e.g., MatchCode and Confidence).

At 508, the result files after DUNS matching and the shipment/cargo data are stored.

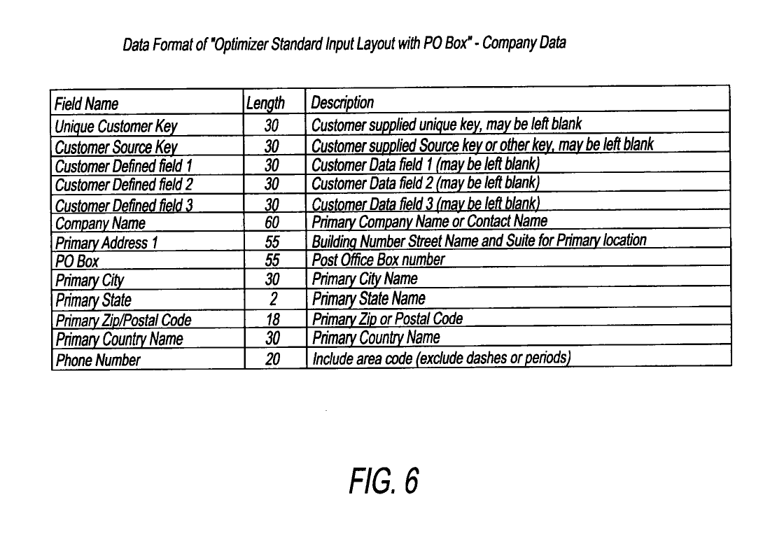

FIG. 6 is an example of a data format of “Optimizer Standard Input Layout with PO Box”-Company Data.

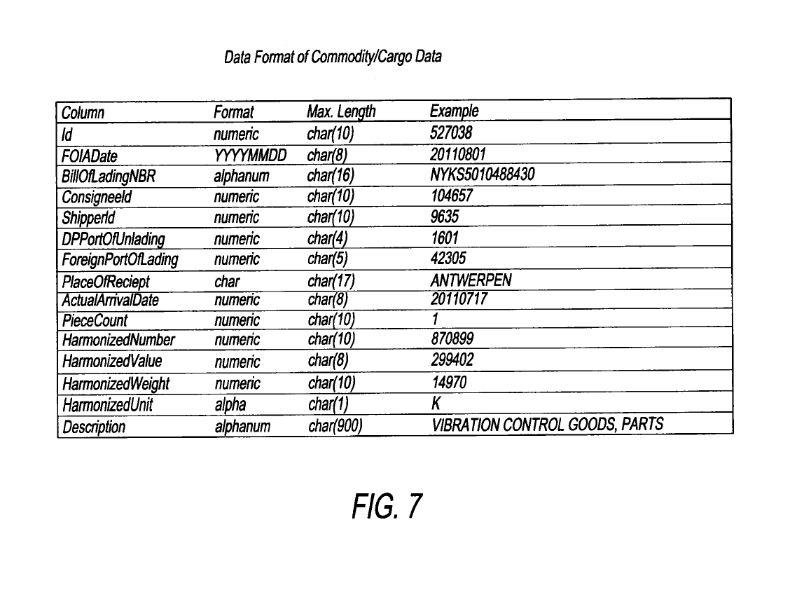

FIG. 7 is an example of a data format of commodity/cargo data.

System 100 provides the following advantages:
(1) enables buyers and sellers to find each other based on the commodity or product being imported or exported (i.e., an online business-to-business (B2B) information platform that leverages the bills of lading information to detect the relationship between the shipper and consignee based on the products being exported and imported);
(2) with the appended corporate identifier, users can analyze the business characteristics of the shipper and consignee, such as location, industry, number of the employees, annual sales, and so on, and therefore, identify prospect companies via a “look-alike” model;
(3) enables buyers and sellers to understand their counter-party's financial stability, payment performance, and other in-depth business insight by linking the bills of lading information with a corporate identifier and corporate information database;
(4) provides insight into global commodity trade trends by combining import/export information from multiple countries upon the availability;
(5) assists in monitoring competitor's import/export activities;
(6) assists in identifying the route of a particular good shipped around the globe so as to identify supply chain interruption risks by combining import/export information from multiple countries upon the availability; and
(7) assists in identifying fraudulent business, international compliance issues and crime. In addition, such combined information will assist buyers in locating products and services throughout the globe, while understanding the creditworthiness of the supplier.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method comprising:
reading, from a first data source, a first record that describes a first international shipping transaction;
parsing said first record to locate a first descriptor of an entity that is involved in said first international shipping transaction;
matching said first descriptor to a unique business identifier, thus yielding a first match to said unique business identifier;
appending first data from said first record to a record in a database, based on said unique business identifier;
reading, from a second data source, a second record that describes a second international shipping transaction;
parsing said second record to locate a second descriptor of an entity that is involved in said second international shipping transaction;
matching said second descriptor to said unique business identifier, thus yielding a second match to said unique business identifier; and
appending second data from said second record to said record in said database, based on said unique business identifier,
wherein said first data and said second data are thereafter accessible by way of said record in said database.

2. The method of claim 1, wherein said first international shipping transaction occurs in a first country, and said second international shipping transaction occurs in a second country.

3. The method of claim 1, wherein said unique business identifier comprises a DUNS Number.

4. The method of claim 1, further comprising, after said matching said first descriptor, and before said appending data from said first record:
qualifying said first match as being a correct match of said first descriptor to said unique business identifier for said entity.

5. The method of claim 1, further comprising:
parsing said first record to locate a description of a commodity;
matching said description of said commodity to a Harmonized Commodity Description and Coding System (HS) number; and
appending said HS number with said first data to said record in said database.

6. The method of claim 1, further comprising:
accessing said first data and said second data by way of said record in said database, thus yielding accessed data, and
executing a procedure that utilizes said accessed data.

7. The method of claim 6, wherein said procedure includes an activity selected from the group consisting of:
(a) identifying a supplier of a product based on the supplier's export activities;
(b) identifying a buyer of a product based on the buyer's import activities;
(c) identifying a “look alike” target of a buyer;
(d) enhance a business profile for a supplier;
(e) enhance a credit profile for a buyer;
(f) mapping a trade trend for a commodity;
(g) detecting a failure of said entity to comply with a regulation;
(h) detecting an involvement of said entity in criminal activity; and
(i) enhancing a credit report by considering an international business activity of said entity.

8. A system comprising:
a processor; and
a memory that contains instructions that when read by said processor, cause said processor to perform actions of:
reading, from a first data source, a first record that describes a first international shipping transaction;
parsing said first record to locate a first descriptor of an entity that is involved in said first international shipping transaction;
matching said first descriptor to a unique business identifier, thus yielding a first match to said unique business identifier;
appending first data from said first record to a record in a database, based on said unique business identifier;
reading, from a second data source, a second record that describes a second international shipping transaction;
parsing said second record to locate a second descriptor of an entity that is involved in said second international shipping transaction;
matching said second descriptor to said unique business identifier, thus yielding a second match to said unique business identifier; and
appending second data from said second record to said record in said database, based on said unique business identifier,
wherein said first data and said second data are thereafter accessible by way of said record in said database.

9. The system of claim 8, wherein said first international shipping transaction occurs in a first country, and said second international shipping transaction occurs in a second country.

10. The system of claim 8, wherein said unique business identifier comprises a DUNS Number.

11. The system of claim 8, wherein said instructions also cause said processor to, after said matching said first descriptor, and before said appending data from said first record, perform an action of:
qualifying said first match as being a correct match of said first descriptor to said unique business identifier for said entity.

12. The system of claim 11, wherein said instructions also cause said processor to perform actions of:
parsing said first record to locate a description of a commodity;
matching said description of said commodity to a Harmonized Commodity Description and Coding System (HS) number; and
appending said HS number with said first data to said record in said database.

13. The system of claim 8, wherein said instructions also cause said processor to perform actions of:
accessing said first data and said second data by way of said record in said database, thus yielding accessed data; and
executing a procedure that utilizes said accessed data.

14. The system of claim 13, wherein said procedure includes an activity selected from the group consisting of:
(a) identifying a supplier of a product based on the supplier's export activities;
(b) identifying a buyer of a product based on the buyer's import activities;
(c) generating a “look alike” target of a buyer;
(d) generating a business profile of a supplier;
(e) generating a credit profile of a buyer;
(f) mapping a trade trend for a commodity;
(g) detecting a failure of said entity to comply with a regulation;
(h) detecting an involvement of said entity in a crime; and
(i) enhancing a credit report by considering an international business activity of said entity.

15. A tangible storage device comprising instructions that are readable by a processor to cause said processor to perform actions of:
reading, from a first data source, a first record that describes a first international shipping transaction;
parsing said first record to locate a first descriptor of an entity that is involved in said first international shipping transaction;
matching said first descriptor to a unique business identifier, thus yielding a first match to said unique business identifier;
appending first data from said first record to a record in a database, based on said unique business identifier; and
reading, from a second data source, a second record that describes a second international shipping transaction;
parsing said second record to locate a second descriptor of an entity that is involved in said second international shipping transaction;
matching said second descriptor to said unique business identifier, thus yielding a second match to said unique business identifier; and
appending second data from said second record to said record in said database, based on said unique business identifier,
wherein said first data and said second data are thereafter accessible by way of said record in said database.

16. The tangible storage device of claim 15, wherein said first international shipping transaction occurs in a first country, and said second international shipping transaction occurs in a second country.

17. The tangible storage medium of claim 15, wherein said unique business identifier comprises a DUNS Number.

18. The tangible storage device of claim 15, wherein said instructions also cause said processor to, after said matching said first descriptor, and before said appending data from said first record, an action of:
qualifying said first match as being a correct match of said first descriptor to said unique business identifier for said entity.

19. The tangible storage device of claim 18, wherein said instructions also cause said processor to perform actions of:
parsing said first record to locate a description of a commodity;
matching said description of said commodity to a Harmonized Commodity Description and Coding System (HS) number; and
appending said HS number with said first data to said record in said database.

20. The tangible storage device of claim 15, wherein said instructions also cause said processor to perform actions of:
accessing said first data and said second data by way of said record in said database, thus yielding accessed data; and
executing a procedure that utilizes said accessed data.

21. The tangible storage device of claim 20, wherein said procedure includes an activity selected from the group consisting of:
(a) identifying a supplier of a product based on the supplier's export activities;
(b) identifying a buyer of a product based on the buyer's import activities;
(c) generating a “look alike” target of a buyer;
(d) generating a business profile of a supplier;
(e) generating a credit profile of a buyer;
(f) mapping a trade trend for a commodity;
(g) detecting a failure of said entity to comply with a regulation;
(h) detecting an involvement of said entity in a crime; and
(i) enhancing a credit report by considering an international business activity of said entity.
